(19) United States
(12) Patent Application Publication
(10) Pub. No.: US 2026/0184898 A1
(43) Pub. Date: Jul. 2, 2026

(54) MOLYBDENUM DISULFIDE NANOTUBE-CARBON NANOTUBE-POLYETHER ETHER KETONE COMPOSITE MATERIAL AND PREPARATION METHOD THEREFOR

(71) Applicant: China Academy of Machinery Wuhan Research Institute of Material Protection Co., Ltd., Wuhan (CN)

(72) Inventors: Haitao Duan, Wuhan (CN); Suling Huang, Wuhan (CN); Shengpeng Zhan, Wuhan (CN); Dan Jia, Wuhan (CN); Lixin Ma, Wuhan (CN); Jinming Ma, Wuhan (CN); Jinhong You, Wuhan (CN)

(21) Appl. No.: 19/422,364

(22) Filed: Dec. 16, 2025

(30) Foreign Application Priority Data
Dec. 26, 2024 (CN) 202411939011.6

(51) Int. Cl. C08K 7/24; B01F 31/80; B29B 7/90; B29C 43/00; B29C 43/58; B29K 71/00; B29K 105/16; B29K 307/04; B29K 309/00; C01G 39/06

(52) U.S. Cl. CPC C08K 7/24; B01F 31/80; B29B 7/90; B29C 43/003; C01G 39/06; B29C 2043/5808; B29C 2043/5816; B29K 2071/00; B29K 2105/167; B29K 2307/04; B29K 2309/00

(57) ABSTRACT

A molybdenum disulfide nanotube-carbon nanotube-polyether ether ketone composite material and a preparation method therefor are provided, relating to the technical field of composite materials. The molybdenum disulfide nanotube-carbon nanotube-polyether ether ketone composite material is made from the following raw materials in parts by weight: 97-99 parts of polyether ether ketone and 1-3 parts of molybdenum disulfide nanotube-carbon nanotube hybrid material. By adding the molybdenum disulfide nanotube-carbon nanotube hybrid material into the polyether ether ketone, compressive properties and hardness of the molybdenum disulfide nanotube-carbon nanotube-polyether ether ketone composite material are improved, and friction reduction and wear resistance effects are also improved.

### CROSS-REFERENCE TO RELATED APPLICATION

This application claims priority to Chinese Patent Application No. 202411939011.6, filed on Dec. 26, 2024, which is herein incorporated by reference in its entirety.

### TECHNICAL FIELD

The disclosure relates to the technical field of composite materials, and more particularly to a molybdenum disulfide nanotube-carbon nanotube-polyether ether ketone composite material and a preparation method therefor.

### BACKGROUND

In related art, polyether ether ketone (PEEK) has been widely used in fields including aerospace, automotive manufacturing, and medical devices due to its excellent thermal stability, dimensional stability, mechanical strength, chemical stability, and processability. However, with rapid development of modern industrial technology, requirements for material properties are constantly improving. For example, when the polyether ether ketone is used in friction pairs, such as radial bearings and bearing bushings, the polyether ether ketone is easy to wear under load, and friction reduction and wear resistance effects of the polyether ether ketone are poor.

### SUMMARY

In view of shortcomings of the aforementioned related technologies, the disclosure aims to provide a molybdenum disulfide nanotube-carbon nanotube-polyether ether ketone composite material and a preparation method therefor. By adding molybdenum disulfide nanotube-carbon nanotube hybrid material into polyether ether ketone, compressive properties and hardness of the molybdenum disulfide nanotube-carbon nanotube-polyether ether ketone composite material are improved, and friction reduction and wear resistance effects are also improved.

In one aspect, the molybdenum disulfide nanotube-carbon nanotube-polyether ether ketone composite material provided by the disclosure uses the following technical solutions.

The molybdenum disulfide nanotube-carbon nanotube-polyether ether ketone composite material is made from the following raw materials in parts by weight: 97-99 parts of the polyether ether ketone and 1-3 parts of the molybdenum disulfide nanotube-carbon nanotube hybrid material.

In an embodiment, the molybdenum disulfide nanotube-carbon nanotube hybrid material is prepared by mixing a precursor, a template agent, an auxiliary solvent, and carbon nanotubes for hydrothermal reaction.

In an embodiment, the precursor includes a molybdenum precursor and a sulfur precursor in a weight ratio of (0.8-0.9):1.

In an embodiment, the precursor includes the molybdenum precursor and the sulfur precursor in the weight ratio of 0.85:1.

In an embodiment, a weight ratio of the molybdenum precursor to the carbon nanotubes is (0.5-10):1.

In an embodiment, the weight ratio of the molybdenum precursor to the carbon nanotubes is (1-5):1.

In an embodiment, the weight ratio of the molybdenum precursor to the carbon nanotubes is 1.18:1.

In an embodiment, a weight ratio of the template agent to the molybdenum precursor is 1:(3.7-3.8).

In an embodiment, the weight ratio of the template agent to the molybdenum precursor is 1:3.74.

In an embodiment, the auxiliary solvent includes water, ethanol, and oleic acid in a volume ratio of (7-8):(2-3):1.

In an embodiment, the auxiliary solvent includes the water, the ethanol, and the oleic acid in the volume ratio of 7.5:2.5:1.

In an embodiment, the template agent includes one or more selected from the group consisting of manganese chloride tetrahydrate, manganese sulfate, and manganese nitrate.

In an embodiment, the molybdenum precursor includes one or more selected from the group consisting of sodium molybdate dihydrate, ammonium molybdate tetrahydrate, potassium molybdate dihydrate, and ammonium dimolybdate.

In an embodiment, the molybdenum precursor is the sodium molybdate dihydrate.

In an embodiment, the sulfur precursor includes one or more selected from the group consisting of thiourea, ammonium thiocyanate, and sodium thiosulfate.

In an embodiment, the sulfur precursor is the thiourea.

In an embodiment, the carbon nanotubes include one or both of multi-walled carbon nanotubes (MWCNTs) and single-walled carbon nanotubes.

In an embodiment, the carbon nanotubes are the multi-walled carbon nanotubes.

In another aspect, the preparation method provided by the disclosure for the molybdenum disulfide nanotube-carbon nanotube-polyether ether ketone composite material uses the following technical solutions.

The preparation method for the molybdenum disulfide nanotube-carbon nanotube-polyether ether ketone composite material includes the following steps:
mixing the molybdenum disulfide nanotube-carbon nanotube hybrid material, the polyether ether ketone, and solvent, followed by ultrasonically dispersing and drying to obtain a mixture; and
performing ball milling on the mixture, followed by drying and finally performing hot press molding to obtain the molybdenum disulfide nanotube-carbon nanotube-polyether ether ketone composite material.

In an embodiment, a rotation speed of the ball milling is in a range of 200 revolutions per minute (rpm) to 400 rpm, and a duration for the ball milling is in a range of 3 hours (h) to 5 h.

In an embodiment, the rotation speed of the ball milling is 300 rpm, and the duration for the ball milling is 4 h.

In an embodiment, the solvent is the ethanol, and a duration for the ultrasonically dispersing is 5 minutes (min) to 40 min.

In an embodiment, the solvent is the ethanol, and the duration for the ultrasonically dispersing is 15 min.

In an embodiment, a temperature of the hot press molding is in a range of 350 degrees Celsius (° C.) to 370° C., a pressure of the hot press molding is in a range of 5 megapascal (MPa) to 10 MPa, and a pressure holding duration of the hot press molding is in a range of 0.5 h to 1.5 h.

In an embodiment, the temperature of the hot press molding is 360° C., the pressure of the hot press molding is 7 MPa, and the pressure holding duration of the hot press molding is 1 h.

To sum up, the disclosure includes at least one of the following beneficial effects.
1. Compared with the polyether ether ketone, a reduction rate of average friction coefficient of the molybdenum disulfide nanotube-carbon nanotube-polyether ether ketone composite material is 20%-23.73%, a reduction rate of wear volume is 77.95%-88.95%, an improvement rate of compressive strength is 11.08%-23.77%, and an improvement rate of surface hardness is 3.06%-5.36%. The compressive properties and the hardness of the molybdenum disulfide nanotube-carbon nanotube-polyether ether ketone composite material are improved, and the friction reduction and wear resistance effects are also improved.
2. Compared with a carbon nanotube-polyether ether ketone composite material, a reduction rate of average friction coefficient of the molybdenum disulfide nanotube-carbon nanotube-polyether ether ketone composite material is 11.36%-17.58%, a reduction rate of wear volume is 30.28%-65.05%, an improvement rate of compressive strength is 4.01%-15.90%, and an improvement rate of surface hardness is 0.60%-2.78%. The compressive properties and the hardness of the molybdenum disulfide nanotube-carbon nanotube-polyether ether ketone composite material are improved, and the friction reduction and wear resistance effects are also improved.

The molybdenum disulfide nanotube-carbon nanotube-polyether ether ketone composite material provided by the disclosure has low difficulty in obtaining the raw materials, a simple preparation method, mild conditions, no need for special equipment, no need for high-concentration chemical reagent modification or coupling agent to improve dispersibility of additives, and is environmentally friendly while reducing preparation costs.

### BRIEF DESCRIPTION OF DRAWINGS

FIG. 1 illustrates a scanning electron microscope image of a molybdenum disulfide nanotube-carbon nanotube hybrid material according to embodiment 5 of the disclosure.

FIG. 2 illustrates a scanning electron microscope image of a molybdenum disulfide nanoflower-carbon nanotube hybrid material according to comparative embodiment 3.

### DETAILED DESCRIPTION OF EMBODIMENTS

The disclosure will be described in detail with reference to embodiments. Embodiments described below are only used to illustrate the disclosure and should not be considered as limiting a scope of protection of the disclosure. When specific conditions are not specified in the following embodiments, the embodiments shall be carried out according to conventional conditions or conditions suggested by manufacturer. Unless otherwise specified, methods used are conventional methods known in the art. Consumables and reagents used are purchased from market unless otherwise specified. Unless otherwise specified, professional and scientific terms used in the specification have the same meanings as those familiar to those skilled in the art. In addition, any method or material similar or equivalent to described content can also be applied to the disclosure.

Raw materials used in both the embodiments and the comparative embodiments can be obtained through commercial sales.

### Embodiment 1

Embodiment 1 of the disclosure provides a molybdenum disulfide nanotube-carbon nanotube-polyether ether ketone composite material prepared by the following steps. A preparation method for a molybdenum disulfide nanotube-carbon nanotube hybrid material includes the following steps. 0.932 grams (g) of sodium molybdate dihydrate as a molybdenum precursor, 1.096 g of thiourea as a sulfur precursor, and 0.249 g of manganese chloride tetrahydrate as a template agent are added into an auxiliary solvent (obtained by mixing 30 milliliters, abbreviated as mL, of water, 10 mL of anhydrous ethanol, and 4 mL of oleic acid), and then vigorously stirred for 30 minutes on a magnetic stirrer at a rotation speed of 700 rpm to obtain a first mixed solution. 0.1 g of multi-walled carbon nanotubes are added into the first mixed solution and then stirred and ultrasonically treated for 20 min to obtain a second mixed solution. The second mixed solution is poured into a 100 mL reactor for hydrothermal reaction with the following reaction parameters: heating at a rate of 1 degree Celsius per minute (° C./min) to 210° C., maintaining a temperature of 210° C. for 12 h, and then slowly cooling to room temperature at a rate of 0.4° C./min to obtain a hydrothermal reaction mixture. The hydrothermal reaction mixture is filtered and then washed to obtain the molybdenum disulfide nanotube-carbon nanotube hybrid material.

A preparation method for the molybdenum disulfide nanotube-carbon nanotube-polyether ether ketone composite material includes the following steps. 98 g of polyether ether ketone powder and 2 g of the molybdenum disulfide nanotube-carbon nanotube hybrid material are accurately weighed. The polyether ether ketone powder and the molybdenum disulfide nanotube-carbon nanotube hybrid material are added to ethanol, then ultrasonically dispersed for 15 min, stirred for 3 h on the magnetic stirrer at a rotation speed of 600 rpm, dried at 80° C. for 4 h, and dried at 100° C. for 2 h to obtain a mixture. The mixture is added to a ball mill and ball milled for 4 h at a rotation speed of 300 rpm and then dried in a drying oven at 120° C. for 3 h to obtain a blended material. The blended material is placed into a mold and hot-pressed under a temperature of 360° C. and a pressure of 7 MPa with a pressure holding duration of 1 h, to thereby obtain the molybdenum disulfide nanotube-carbon nanotube-polyether ether ketone composite material.

### Embodiment 2

Embodiment 2 of the disclosure provides a molybdenum disulfide nanotube-carbon nanotube-polyether ether ketone composite material. Differences between embodiment 2 and embodiment 1 lie in that when preparing the molybdenum disulfide nanotube-carbon nanotube hybrid material, embodiment 2 uses 0.876 g of the sodium molybdate dihydrate, 1.03 g of the thiourea, 0.235 g of the manganese chloride tetrahydrate, and 0.125 g of the multi-walled carbon nanotubes.

### Embodiment 3

Embodiment 3 of the disclosure provides a molybdenum disulfide nanotube-carbon nanotube-polyether ether ketone composite material. Differences between embodiment 3 and embodiment 1 lie in that when preparing the molybdenum disulfide nanotube-carbon nanotube hybrid material, embodiment 3 uses 0.766 g of the sodium molybdate dihydrate, 0.901 g of the thiourea, 0.205 g of the manganese chloride tetrahydrate, and 0.167 g of the multi-walled carbon nanotubes.

### Embodiment 4

Embodiment 4 of the disclosure provides a molybdenum disulfide nanotube-carbon nanotube-polyether ether ketone composite material. Differences between embodiment 4 and embodiment 1 lie in that when preparing the molybdenum disulfide nanotube-carbon nanotube hybrid material, embodiment 4 uses 0.5825 g of the sodium molybdate dihydrate, 0.685 g of the thiourea, 0.156 g of the manganese chloride tetrahydrate, and 0.25 g of the multi-walled carbon nanotubes.

### Embodiment 5

Embodiment 5 of the disclosure provides a molybdenum disulfide nanotube-carbon nanotube-polyether ether ketone composite material. Differences between embodiment 5 and embodiment 1 lie in that when preparing the molybdenum disulfide nanotube-carbon nanotube hybrid material, embodiment 5 uses 0.389 g of the sodium molybdate dihydrate, 0.458 g of the thiourea, 0.104 g of the manganese chloride tetrahydrate, and 0.33 g of the multi-walled carbon nanotubes.

### Embodiment 6

Embodiment 6 of the disclosure provides a molybdenum disulfide nanotube-carbon nanotube-polyether ether ketone composite material. Differences between embodiment 6 and embodiment 1 lie in that when preparing the molybdenum disulfide nanotube-carbon nanotube hybrid material, embodiment 6 uses 0.291 g of the sodium molybdate dihydrate, 0.343 g of the thiourea, 0.078 g of the manganese chloride tetrahydrate, and 0.325 g of the multi-walled carbon nanotubes.

### Embodiment 7

Embodiment 7 of the disclosure provides a molybdenum disulfide nanotube-carbon nanotube-polyether ether ketone composite material. Differences between embodiment 7 and embodiment 1 lie in that when preparing the molybdenum disulfide nanotube-carbon nanotube hybrid material, embodiment 7 uses 0.233 g of the sodium molybdate dihydrate, 0.274 g of the thiourea, 0.062 g of the manganese chloride tetrahydrate, and 0.4 g of the multi-walled carbon nanotubes.

### Comparative Embodiment 1

Comparative embodiment 1 provides a polyether ether ketone prepared by the following steps. 100 g of polyether ether ketone powder is accurately weighed. The polyether ether ketone powder is added to ethanol, ultrasonically dispersed for 15 min, stirred for 3 h on a magnetic stirrer at a rotation speed of 600 rpm, dried at 80° C. for 4 h, and dried at 100° C. for 2 h to obtain firstly treated polyether ether ketone powder. The firstly treated polyether ether ketone powder is added to a ball mill and ball milled for 4 h at a rotation speed of 300 rpm and then dried in a drying oven at 120° C. for 3 h to obtain a secondly treated polyether ether ketone powder. The secondly treated polyether ether ketone powder is placed into a mold and hot-pressed under a temperature of 360° C. and a pressure of 7 MPa with a pressure holding duration of 1 h, to thereby obtain the polyether ether ketone.

### Comparative Embodiment 2

Comparative embodiment 2 provides a carbon nanotube-polyether ether ketone composite material prepared by the following steps. Multi-walled carbon nanotubes are added into an auxiliary solvent (obtained by mixing 30 mL of water, 10 mL of anhydrous ethanol, and 4 mL of oleic acid), then stirred for 30 min, followed by keeping stirring and ultrasonically treating for 20 min to obtain a first mixed solution. The first mixed solution is poured into a 100 mL reactor, then heated to 220° C. at a rate of 1° C./min, left at a temperature of 220° C. for 24 h, and slowly cooled to room temperature at a rate of 0.4° C./min, followed by filtering and washing to obtain treated multi-walled carbon nanotubes.

98 g of polyether ether ketone powder and 2 g of the treated multi-walled carbon nanotubes are accurately weighed. The polyether ether ketone powder and the treated multi-walled carbon nanotubes are added to ethanol, then ultrasonically dispersed for 15 min, stirred for 3 h on the magnetic stirrer at a rotation speed of 600 rpm, dried at 80° C. for 4 h, and dried at 100° C. for 2 h to obtain a mixture. The mixture is added to a ball mill and ball milled for 4 h at a rotation speed of 300 rpm and then dried in a drying oven at 120° C. for 3 h to obtain a blended material. The blended material is placed into a mold and hot-pressed under a temperature of 360° C. and a pressure of 7 MPa with a pressure holding duration of 1 h, to thereby obtain the carbon nanotube-polyether ether ketone composite material.

### Comparative Embodiment 3

Comparative embodiment 3 provides a molybdenum disulfide nanoflower-carbon nanotube-polyether ether ketone composite material provided by the following steps. A preparation method for a molybdenum disulfide nanoflower-carbon nanotube hybrid material includes the following steps. 0.2247 g of ammonium molybdate tetrahydrate as a molybdenum precursor, 0.4494 g of thiourea as a sulfur precursor, and 0.0281 g of hexadecyl trimethyl ammonium bromide as a surfactant are added to 40 mL of deionized water and then stirred for 30 min to obtain a first mixed solution. 0.33 g of multi-walled carbon nanotubes are added into the first mixed solution and then stirred and ultrasonically treated for 20 min to obtain a second mixed solution. The second mixed solution is poured into a 100 mL reactor for hydrothermal reaction with the following reaction parameters: heating at a rate of 1° C./min to 220° C., maintaining a temperature of 220° C. for 24 h, and then slowly cooling to room temperature at a rate of 0.4° C./min to obtain a hydrothermal reaction mixture. The hydrothermal reaction mixture is filtered and then washed to obtain the molybdenum disulfide nanoflower-carbon nanotube hybrid material.

A preparation method for the molybdenum disulfide nanoflower-carbon nanotube-polyether ether ketone composite material includes the following steps. 98 g of polyether ether ketone powder and 2 g of the molybdenum disulfide nanoflower-carbon nanotube hybrid material are accurately weighed. The polyether ether ketone powder and the molybdenum disulfide nanoflower-carbon nanotube hybrid material are added to ethanol, then ultrasonically dispersed for 15 min, stirred for 3 h on the magnetic stirrer at a rotation speed of 600 rpm, dried at 80° C. for 4 h, and dried at 100° C. for 2 h to obtain a mixture. The mixture is added to a ball mill and ball milled for 4 h at a rotation speed of 300 rpm and then dried in a drying oven at 120° C. for 3 h to obtain a blended material. The blended material is placed into a mold and hot-pressed under a temperature of 360° C. and a pressure of 7 MPa with a pressure holding duration of 1 h, to thereby obtain the molybdenum disulfide nanoflower-carbon nanotube-polyether ether ketone composite material.

### Test and Detection

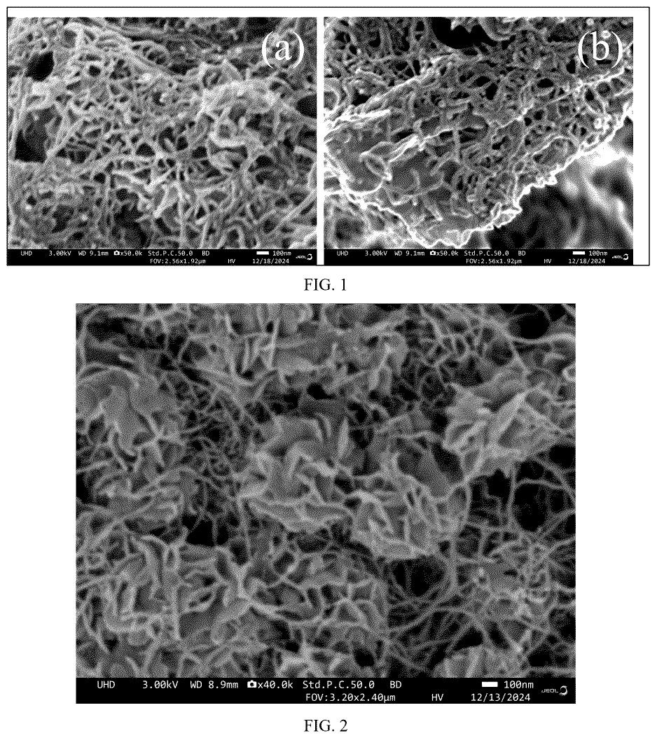

(1) The molybdenum disulfide nanotube-carbon nanotube hybrid material prepared in embodiment 5 and the molybdenum disulfide nanoflower-carbon nanotube hybrid material prepared in comparative embodiment 3 are imaged by scanning electron microscopy to obtain scanning electron microscope images. The obtained scanning electron microscope images are illustrated in FIG. 1 and FIG. 2, respectively.
(2) Compressive properties of the molybdenum disulfide nanotube-carbon nanotube-polyether ether ketone composite materials prepared in embodiments 1-7, the polyether ether ketone prepared in comparative embodiment 1, the carbon nanotube-polyether ether ketone composite material prepared in comparative embodiment 2, and the molybdenum disulfide nanoflower-carbon nanotube-polyether ether ketone composite material prepared in comparative embodiment 3 are tested on a universal testing machine according to International Organization for Standardization (ISO) 604:2002 (Plastics—Determination of compressive properties). Sizes of samples are 10 mm×10 mm×4 mm, and a testing condition is 1 millimeter per minute (mm/min). Compressive property test results are shown in Table 1 below.
(3) Surface hardnesses of the molybdenum disulfide nanotube-carbon nanotube-polyether ether ketone composite materials prepared in embodiments 1-7, the polyether ether ketone prepared in comparative embodiment 1, the carbon nanotube-polyether ether ketone composite material prepared in comparative embodiment 2, and the molybdenum disulfide nanoflower-carbon nanotube-polyether ether ketone composite material prepared in comparative embodiment 3 are tested on a Shore hardness tester according to ISO 868 (Plastics and ebonite-Determination of indentation hardness by means of a durometer (Shore hardness)). Sizes of samples are 20 mm×10 mm×4 mm. Surface hardness test results are shown in Table 1 below.

TABLE 1

| | Compressive | Surface hardness |
|---|---|---|
| | Strength | (hardness durometer, |
| Data source | (MPa) | abbreviated as HD) |
| Embodiment 1 | 170.24 | 88.58 |
| Embodiment 2 | 173.25 | 88.67 |
| Embodiment 3 | 174.91 | 88.75 |
| Embodiment 4 | 177.41 | 89.17 |
| Embodiment 5 | 184.79 | 90.08 |
| Embodiment 6 | 168.54 | 88.25 |
| Embodiment 7 | 165.84 | 88.17 |
| Comparative embodiment 1 | 149.3 | 85.5 |
| Comparative embodiment 2 | 159.44 | 87.64 |
| Comparative embodiment 3 | 173.99 | 88.71 |

(4). The molybdenum disulfide nanotube-carbon nanotube-polyether ether ketone composite materials prepared in embodiments 1-7, the polyether ether ketone prepared in comparative embodiment 1, the carbon nanotube-polyether ether ketone composite material prepared in comparative embodiment 2, and the molybdenum disulfide nanoflower-carbon nanotube-polyether ether ketone composite material prepared in comparative embodiment 3 are subjected to ball-disc reciprocating friction tests on a tribometer purchased from Rtec Instruments company. GCr15 (i.e., high-carbon chromium bearing steel) steel balls with a diameter of 6.3 mm are subjected to reciprocating friction with the molybdenum disulfide nanotube-carbon nanotube-polyether ether ketone composite materials with sizes of 20 mm×10 mm×4 mm. Test conditions include a load of 80 newtons (N), a duration of 30 min, and a speed of 6 hertz (Hz), namely a linear velocity of 96 millimeters per second (mm/s). Test results are shown in Table 2.

TABLE 2

| | | Wear volume (10⁻⁶ cubic |
|---|---|---|
| | Average | millimeters per newton per |
| | friction | meter, abbreviated as |
| Data source | coefficient | mm³/N · m) |
| Embodiment 1 | 0.233 | 7.79 |
| Embodiment 2 | 0.231 | 7.54 |
| Embodiment 3 | 0.23 | 7.08 |
| Embodiment 4 | 0.227 | 6.69 |
| Embodiment 5 | 0.225 | 6.06 |
| Embodiment 6 | 0.236 | 8.21 |
| Embodiment 7 | 0.242 | 12.09 |
| Comparative embodiment 1 | 0.295 | 54.83 |
| Comparative embodiment 2 | 0.273 | 17.34 |
| Comparative embodiment 3 | 0.225 | 7.09 |

### Result Analysis

In the following, the disclosure will be described in detail in combination with experimental data provided in Tables 1-2 and FIG. 1 through FIG. 2.

The molybdenum disulfide nanotube-carbon nanotube hybrid materials prepared in embodiments 1-7 of the disclosure all have molybdenum disulfide nanotube-carbon nanotube hybrid structures successfully formed by the multi-walled carbon nanotubes being tightly wrapped around molybdenum disulfide nanotube structures. The molybdenum disulfide nanotube-carbon nanotube hybrid material prepared in embodiment 5 is illustrated in FIG. 1. It can be seen from FIG. 1(a) that the multi-walled carbon nanotubes and molybdenum disulfide nanotubes in the molybdenum disulfide nanotube-carbon nanotube hybrid material form a compact three-dimensional network structure as a whole. It can be seen from FIG. 1(b) that the multi-walled carbon nanotubes are interwoven and wrapped around the molybdenum disulfide nanotubes, with a compact distribution.

As shown in Table 1, the molybdenum disulfide nanotube-carbon nanotube-polyether ether ketone composite materials prepared in embodiments 1-7 have significantly improved compressive strength and surface hardness compared to the polyether ether ketone prepared in comparative embodiment 1 and the carbon nanotube-polyether ether ketone composite material prepared in comparative embodiment 2. This indicates that addition of the molybdenum disulfide nanotube-carbon nanotube hybrid material is beneficial to improve mechanical properties of the polyether ether ketone and its composites. Especially when a weight ratio of sodium molybdate dihydrate to the multi-walled carbon nanotubes is 1.18:1, the compressive strength of the molybdenum disulfide nanotube-carbon nanotube-polyether ether ketone composite material prepared in embodiment 1 increases by about 23.77% (from 149.3 MPa to 184.79 MPa) compared to the polyether ether ketone prepared in comparative embodiment 1, and the surface hardness also increases by 5.36% (from 85.5 HD to 90.08 HD). Compared with the carbon nanotube-polyether ether ketone composite material prepared in comparative embodiment 2, the compressive strength and surface hardness of the molybdenum disulfide nanotube-carbon nanotube-polyether ether ketone composite material also increase significantly. This indicates that the molybdenum disulfide nanotube structures and carbon nanotube structure in the molybdenum disulfide nanotube-carbon nanotube hybrid material prepared by regulating a ratio of a molybdenum precursor to carbon nanotubes between (0.5-10):1 have a synergistic effect on improving the mechanical properties of polyether ether ketone-based composites.

As shown in Table 2, the molybdenum disulfide nanotube-carbon nanotube-polyether ether ketone composite materials prepared in embodiments 1-7 exhibit lower friction coefficients and superior wear resistance in friction and wear tests compared to polyether ether ketone prepared in comparative embodiment 1 and the carbon nanotube-polyether ether ketone composite material prepared in comparative embodiment 2. Especially when the weight ratio of the sodium molybdate dihydrate to the multi-walled carbon nanotubes is 1.18:1, the friction coefficient of the molybdenum disulfide nanotube-carbon nanotube-polyether ether ketone composite material prepared in embodiment 1 decreases by about 23.73% (from 0.295 to 0.225) compared to the polyether ether ketone prepared in comparative embodiment 1, wear resistance increases by 88.95% (wear volume decreases from 54.83×10⁻⁶ mm³/N·m to 6.06×10⁻⁶ mm³/N·m), and friction reduction and wear resistance effects of the molybdenum disulfide nanotube-carbon nanotube-polyether ether ketone composite materials prepared in embodiments 1-7 increase significantly compared to that of the carbon nanotube-polyether ether ketone composite material prepared in comparative embodiment 2. This indicates that the molybdenum disulfide nanotube structures and the carbon nanotube structures in the molybdenum disulfide nanotube-carbon nanotube hybrid material prepared by regulating the ratio of the molybdenum precursor to the carbon nanotubes between (0.5-10):1 have the synergistic effect on improving the mechanical properties of polyether ether ketone-based composites.

To sum up, the molybdenum disulfide nanotube-carbon nanotube-polyether ether ketone composite materials prepared in embodiments 1-7 have significant advantages in mechanical and tribological properties compared to the polyether ether ketone prepared in comparative embodiment 1 and the carbon nanotube-polyether ether ketone composite material prepared in comparative embodiment 2. Analysis indicates that the molybdenum disulfide nanotube-carbon nanotube hybrid material formed by the molybdenum disulfide nanotubes and the multi-walled carbon nanotubes provides an effective stress transfer network for the polyether ether ketone-based composites, and hollow tubular structures of both the molybdenum disulfide nanotubes and the multi-walled carbon nanotubes in the molybdenum disulfide nanotube-carbon nanotube hybrid material contribute to further enhancing lubrication performance of the molybdenum disulfide nanotube-carbon nanotube-polyether ether ketone composite. Under the synergistic effect of the molybdenum disulfide nanotubes and multi-walled carbon nanotubes in the molybdenum disulfide nanotube-carbon nanotube hybrid material, the mechanical and tribological properties of the molybdenum disulfide nanotube-carbon nanotube-polyether ether ketone composite material are improved simultaneously.

Further, as illustrated in FIG. 2, in the molybdenum disulfide nanoflower-carbon nanotube-polyether ether ketone composite material prepared in comparative embodiment 3, molybdenum disulfide nanoflowers are connected by the multi-walled carbon nanotubes to form the molybdenum disulfide nanoflower-carbon nanotube hybrid material. Taking the molybdenum disulfide nanoflower-carbon nanotube-polyether ether ketone composite material prepared in comparative embodiment 3 as a control, a ratio of the molybdenum disulfide nanotubes to the carbon nanotubes in the molybdenum disulfide nanotube-carbon nanotube-polyether ether ketone composite material prepared in embodiment 5 is comparable to a ratio of the molybdenum disulfide nanoflowers to the carbon nanotubes in the molybdenum disulfide nanoflower-carbon nanotube-polyether ether ketone composite material prepared in comparative embodiment 3. However, the molybdenum disulfide nanotube-carbon nanotube-polyether ether ketone composite material prepared in embodiment 5 exhibits superior mechanical properties (compressive strength and surface hardness) and tribological properties (wear resistance) compared to the molybdenum disulfide nanoflower-carbon nanotube-polyether ether ketone composite material prepared in comparative embodiment 3. Moreover, the compressive properties, surface hardnesses, and wear resistances of the molybdenum disulfide nanotube-carbon nanotube-polyether ether ketone composite materials prepared in embodiments 3-5 are superior to those of the molybdenum disulfide nanoflower-carbon nanotube-polyether ether ketone composite material prepared in comparative embodiment 3, indicating that the weight ratio of the sodium molybdate dihydrate to the multi-walled carbon nanotubes being (1-5):1 is beneficial for further improving the mechanical properties and wear resistance of the molybdenum disulfide nanotube-carbon nanotube-polyether ether ketone composite material.

This specific embodiment is only an explanation of the disclosure and is not intended to limit the disclosure. After reading this specification, those skilled in the art may make modifications to the embodiment as needed without creative contributions, but any modifications within a scope of the claims of the disclosure are protected by the Patent Law.

What is claimed is:

1. A molybdenum disulfide nanotube-carbon nanotube-polyether ether ketone composite material, made from the following raw materials in parts by weight: 97-99 parts of polyether ether ketone and 1-3 parts of molybdenum disulfide nanotube-carbon nanotube hybrid material;
wherein the molybdenum disulfide nanotube-carbon nanotube hybrid material is prepared by mixing a precursor, a template agent, an auxiliary solvent, and carbon nanotubes for hydrothermal reaction; and
wherein the precursor comprises a molybdenum precursor and a sulfur precursor in a weight ratio of (0.8-0.9):1; a weight ratio of the template agent to the molybdenum precursor is 1:(3.7-3.8); and the template agent comprises one or more selected from the group consisting of manganese chloride tetrahydrate, manganese sulfate, and manganese nitrate.

2. The molybdenum disulfide nanotube-carbon nanotube-polyether ether ketone composite material as claimed in claim 1, wherein a weight ratio of the molybdenum precursor to the carbon nanotubes is (0.5-10):1.

3. The molybdenum disulfide nanotube-carbon nanotube-polyether ether ketone composite material as claimed in claim 1, wherein the auxiliary solvent includes water, ethanol, and oleic acid in a volume ratio of (7-8):(2-3):1.

4. A preparation method for the molybdenum disulfide nanotube-carbon nanotube-polyether ether ketone composite material as claimed in claim 1, comprising the following steps:
mixing the molybdenum disulfide nanotube-carbon nanotube hybrid material, the polyether ether ketone, and solvent, followed by ultrasonically dispersing and drying to obtain a mixture; and
performing ball milling on the mixture, followed by drying, and finally performing hot press molding to obtain the molybdenum disulfide nanotube-carbon nanotube-polyether ether ketone composite material.

5. The preparation method for the molybdenum disulfide nanotube-carbon nanotube-polyether ether ketone composite material as claimed in claim 4, wherein a rotation speed of the ball milling is in a range of 200 revolutions per minute (rpm) to 400 rpm, and a duration for the ball milling is in a range of 3 hours (h) to 5 h.

6. The preparation method for the molybdenum disulfide nanotube-carbon nanotube-polyether ether ketone composite material as claimed in claim 4, wherein a temperature of the hot press molding is in a range of 350 degrees Celsius (C) to 370° C., a pressure of the hot press molding is in a range of 5 megapascal (MPa) to 10 MPa, and a pressure holding duration of the hot press molding is in a range of 0.5 h to 1.5 h.
